(19) United States
(12) Patent Application Publication
(10) Pub. No.: US 2022/0258707 A1
(43) Pub. Date: Aug. 18, 2022

(54) SYSTEM AND METHOD OF CONTROLLING BRAKE OF VEHICLE

(71) Applicants: Hyundai Motor Company, Seoul (KR); Kia Corporation, Seoul (KR)

(72) Inventors: So Ra Jang, Gyeonggi-do (KR); Ho Wook Lee, Seoul (KR)

(21) Appl. No.: 17/521,685

(22) Filed: Nov. 8, 2021

(30) Foreign Application Priority Data
Feb. 16, 2021 (KR) 10-2021-0020325

(51) Int. Cl. B60T 8/1755; B60T 8/32

(52) U.S. Cl. CPC B60T 8/17552; B60T 2240/04; B60T 2250/03; B60T 8/3205

(57) ABSTRACT

A brake control system and method are arranged to control a brake for preventing slip and ensuring driving force of an outer wheel by adjusting a braking amount of an inner wheel during vehicle turning. The method includes steps of: receiving, by an electronic stability control (ESC) device, a function activation request; determining, by the ESC device, whether execution conditions for brake control of a turning inner wheel of a vehicle are satisfied in response to the function activation request, and when the execution conditions are satisfied, controlling braking pressure by determining and adjusting a braking pressure control amount of an inner wheel during vehicle turning based on a preset factor.

### CROSS-REFERENCE TO RELATED APPLICATION

This application claims under 35 U.S.C. § 119(a) the benefit of Korean Patent Application No. 10-2021-0020325, filed on Feb. 16, 2021, the entire contents of which are incorporated herein by reference.

### BACKGROUND

### (a) Technical Field

The present disclosure relates to a system and method of controlling a brake of a vehicle, more particularly, to the system and method of controlling the brake for preventing slippage and ensuring driving force of an outer wheel by adjusting a braking amount of an inner wheel during vehicle turning.

### (b) Description of the Related Art

A differential gear is a device required in a vehicle to enable turning of the vehicle. The differential gear allows the vehicle to turn by compensating for a difference in revolutions-per-minute (RPM) between inner and outer wheels.

When a vehicle turns, slippage occurs at an inner wheel of driving wheels due to movement of a load. In particular, when a large difference in speed is present between the inner and outer wheels, a sufficient amount of driving force may not be transferred from the slipped inner wheel to the outer wheel, which is positioned opposite to the inner wheel among the driving wheels, due to the differential gear.

In order to counteract limitations of the differential gear, a mechanical device, such as a limited slip differential (LSD), is generally utilized. Although an apparatus, such as an LSD, advantageously prevents slippage, the overall cost and weight of the vehicle may increase, and a change of layout is necessary when a mechanical device including a clutch is utilized. Also, development costs may be required to conduct research and development of implementing the mechanical device in different vehicles.

### SUMMARY

In one aspect, the present disclosure provides a system and method of controlling a brake for overcoming a problem in which driving force is not transferred to an outer wheel when slippage of an inner wheel occurs during vehicle turning without application of a mechanical device such as a limited slip differential (LSD).

The technical problems solved by the embodiments are not limited to the above technical problems and other technical problems which are not described herein will become apparent to those skilled in the art from the following description.

The present disclosure has the following features in order to achieve the aforementioned objective of the present disclosure and to perform characteristic functions according to the present disclosure.

In one aspect, the present disclosure provides a method of controlling a brake, the method including receiving a function activation request, determining whether execution conditions for brake control of a turning inner wheel of a vehicle are satisfied in response to the function activation request, and when the execution conditions are satisfied, controlling braking pressure by determining and adjusting a braking pressure control amount of an inner wheel during vehicle turning based on a preset factor.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a diagram showing configuration of a brake control system according to the present disclosure;

FIG. 2 is a flowchart showing an operation of an execution condition determiner of a brake control system according to the present disclosure;

FIG. 3 is a schematic diagram showing execution conditions of a brake control system according to the present disclosure;

FIG. 4 is a flowchart showing an operation of a turning inner and outer wheel determiner of a brake control system according to the present disclosure;

FIG. 5 is a diagram showing an example of the characteristics of a tire of a certain vehicle;

FIG. 6 is a flowchart of a brake control method according to the present disclosure; and

FIG. 7 is a flowchart of a brake control method according to some embodiments of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, preferred embodiments of the present disclosure will be described in detail with reference to the accompanying drawings. Specific structures or functions described in the embodiments of the present disclosure are merely for illustrative purposes. Embodiments according to the concept of the present disclosure may be implemented in various forms, and it should be understood that they should not be construed as being limited to the embodiments described in the present specification, but include all of modifications, equivalents, or substitutes included in the spirit and scope of the present disclosure.

It will be understood that, although the terms “first,” “second,” etc., may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,” “directly between,” “adjacent to,” or “directly adjacent to,” should be construed in the same way.

Like reference numerals denote like components throughout the specification. In the meantime, the terminology used herein is for the purpose of describing particular embodiments only and is not intended to be limiting.

The present disclosure may resolve a problem in which driving force is not transferred to an outer wheel when slippage occurs at an inner wheel during vehicle turning by adjusting a braking pressure instead of a mechanical device, such as a limited slip differential (LSD).

In particular, according to the present disclosure, a braking pressure may be adjusted using an electronic stability control (ESC) system included in a vehicle without implementing a new, separate system. In particular, according to the present disclosure, driving force may be transferred to the outer wheel by determining slippage at the inner wheel and preventing slippage through a hydraulic brake pressure using an ESC system.

Accordingly, the present disclosure may provide a dynamic driving environment to a driver by improving performance for escaping from turning and a drift function (e.g., on a racetrack).

Compared with a vehicle to which a conventional mechanical device is applied, the cost and weight of a vehicle according to the present disclosure may be remarkably reduced, and it may not be required to consider a layout design for installing such a mechanical device.

In addition, the development cost and manpower used to apply the conventional mechanical device to different vehicle models may be reduced.

Hereinafter reference will be made in detail to various embodiments of the present disclosure, examples of which are illustrated in the accompanying drawings and described below.

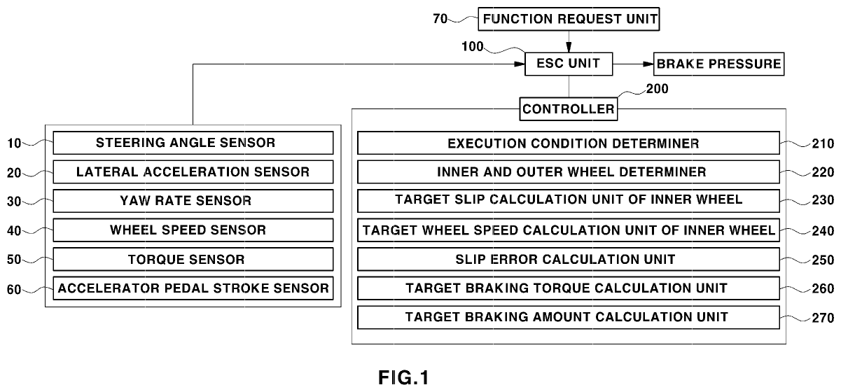

As shown in FIG. 1, a brake control system according to the present disclosure may include an electronic stability control (ESC) unit (or device) 100 and a controller 200 for brake control according to the present disclosure. The controller 200 may be integrated into the ESC unit 100 or may be a separate controller configured to communicate with the ESC unit 100. Hereinafter, the present disclosure will be described in terms of the controller 200 integrated into the ESC unit 100.

The ESC unit 100 may be configured to receive measurement information from various sensors of a vehicle in real time. In particular, the ESC unit 100 may receive information on a steering angle of the vehicle from a steering angle sensor 10, may receive information on a lateral acceleration from a lateral acceleration sensor 20, and may collect information on a yaw rate from a yaw rate sensor 30. The ESC unit 100 may collect information on wheel speeds from wheel speed sensors 40 of the vehicle. The ESC unit 100 may acquire information on driving torque from a torque sensor 50 and may collect information on change in accelerator pedal stroke from an accelerator pedal stroke sensor 60.

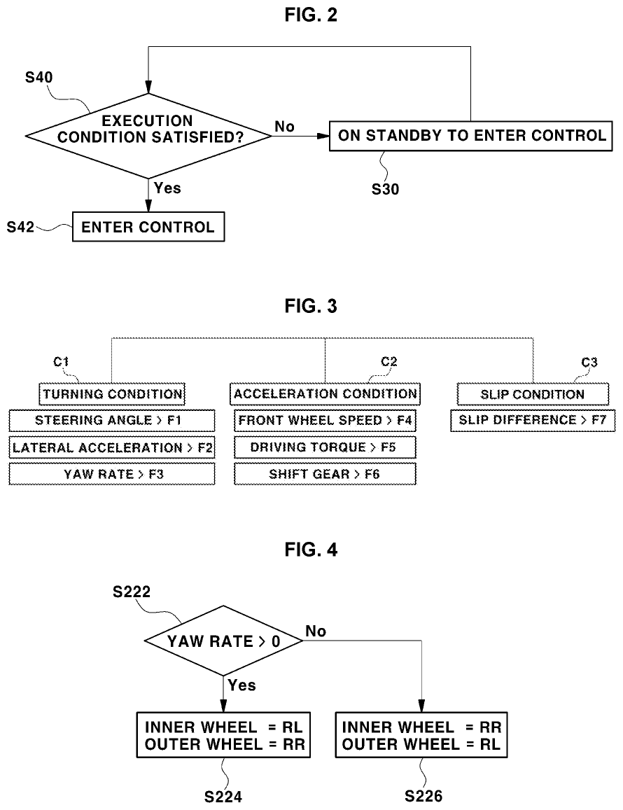

The ESC unit 100 may receive input of a function request unit 70. According to an embodiment of the present disclosure, the function request unit 70 may be a function activation button installed in a passenger compartment and may receive ON and OFF input by a driver. In particular, when the driver wishes to drive on a racetrack or drift, brake control according to the present disclosure may be performed by manipulating the function request unit 70. When the function request unit 70 receives an ON input, the ESC unit 100 may be on standby to perform brake control according to the present disclosure and may be configured to control a brake according to the present disclosure when execution conditions to be described below is satisfied. That is, as shown in FIG. 2, after the function is activated, whether the execution conditions are satisfied may be determined in standby (S40). When the execution conditions for performing brake control are satisfied, brake control may be performed (S42, entry into control). When the execution conditions are not satisfied, the brake control system may stay on standby (S30, standby on to enter control).

The ESC unit 100 may include an execution condition determiner 210. The execution condition determiner 210 may determine whether hydraulic brake pressure needs to be actually controlled to prevent wheel slippage on standby to perform brake control. As shown in FIG. 3, the execution condition determiner 210 may determine a turning condition C1, an acceleration condition C2, and a slip condition C3. When these conditions C1, C2, and C3 are satisfied, operations for braking pressure control according to the present disclosure may be performed.

The execution condition determiner 210 may determine whether the turning condition C1 is satisfied based on a current steering angle, lateral acceleration, and yaw rate of a vehicle. The steering angle may be input to the execution condition determiner 210 from the steering angle sensor 10, the lateral acceleration may be input to the execution condition determiner 210 from the lateral acceleration sensor 20, and the yaw rate may be input to the execution condition determiner 210 from the yaw rate sensor 30. When the steering angle is greater than a preset reference steering angle F1, the lateral acceleration is greater than a preset reference lateral acceleration F2, and the yaw rate is greater than a preset reference yaw rate F3, that is, when all three conditions are satisfied, the execution condition determiner 210 may determine that the turning condition C1 is satisfied.

The execution condition determiner 210 may determine whether the acceleration condition C2 is satisfied based on information on the front wheel speed, driving toque, and shift gear of the vehicle. That is, when the front wheel speed is greater than a preset reference front wheel speed F4, the driving toque is greater than preset reference driving torque F5, and the shift gear is a preset reference shift gear F6, that is, when all three conditions are satisfied, the execution condition determiner 210 may determine that the acceleration condition C2 is satisfied.

The execution condition determiner 210 may be configured to determine whether the slip condition C3 is satisfied. When a slip difference between inner and outer wheels of driving wheels is greater than a preset reference slip difference F7, the execution condition determiner 210 may determine that the slip condition C3 is satisfied.

In this case, determination which one is the inner wheel when the vehicle is turning and which one is the outer wheel when the vehicle turning may be preceded. The ESC unit 100 may include an inner and outer wheel determiner 220. The inner and outer wheel determiner 220 may determine whether the inner wheel when the vehicle is turning is a left wheel or a right wheel. As shown in FIG. 4, according to an embodiment of the present disclosure, the inner and outer wheel determiner 220 may collect information on the current yaw rate from the yaw rate sensor 30 and may determine whether the yaw rate has a negative value or a positive value (S222). When the collected yaw rate is greater than 0, the inner and outer wheel determiner 220 may determine that the inner wheel is a rear left wheel RL and the outer wheel is a rear right wheel RR (S224). In contrast, when the yaw rate has a negative value less than 0, the inner and outer wheel determiner 220 may determine that the inner wheel is a rear right wheel RR and the outer wheel is a rear left wheel RL (S226). Here, a left side means a driver's side, and a right side means a passenger's side. Depending on settings, the converse may be possible.

When the execution conditions including the turning condition C1, the acceleration condition C2, and the slip condition C3 are satisfied, the ESC unit 100 may perform a series of operations for braking pressure control. That is, the ESC unit 100 may determine a braking pressure control amount and may control a braking pressure based on the determined braking pressure control amount. To this end, according to an embodiment of the present disclosure, the ESC unit 100 may include a target slip calculation unit 230 of the inner wheel, a target wheel speed calculation unit 240 of the inner wheel, a slip error calculation unit 250, a target braking torque calculation unit 260, and a target braking amount calculation unit 270.

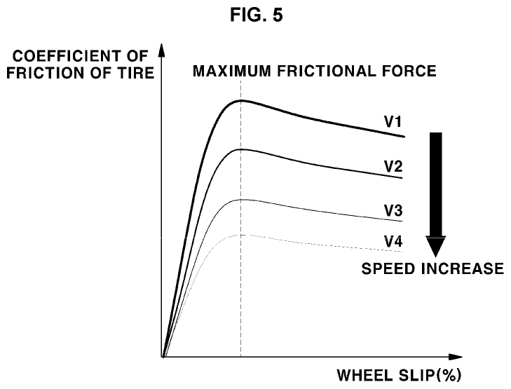

The target slip calculation unit 230 of the inner wheel may be configured to calculate target slip of a turning inner wheel. An objective of brake control according to the present disclosure may be to limit slip of the turning inner wheel according to the characteristics of the vehicle in order to ensure the maximum driving force. Since the maximum driving force may change depending on the characteristics of a tire of a vehicle, corresponding to friction of the tire due to slip, slip for ensuring the maximum driving force may be determined based on a tire characteristic value. When a test value of tire characteristics is input as a parameter, the target slip calculation unit 230 of the inner wheel may determine a maximum slip rate corresponding to the current driving speed and may determine a target slip λ_{target}. For example, when the characteristics of a tire of a certain vehicle is given as shown in FIG. 5, proper target slip for ensuring the maximum driving force may be given as shown in Table 1 below.

TABLE 1

| Speed | 10 | . . . | 40 | 60 | . . . | Vmax |
|---|---|---|---|---|---|---|
| Target slip of | 15 | . . . | 10 | 5 | . . . | 2 |
| inner wheel | | | | | | |

As described above, a target wheel speed V_{iw.target} of the inner wheel may be calculated from the target slipλ_{target} of the inner wheel determined by the target slip calculation unit 230 of the inner wheel. According to a formula for calculating wheel slip, an equation for the target slip λ_{target} of the inner wheel may be obtained as shown in Equation 1.

$${λ}_{target} = \frac{V - {V}_{iw , target}}{V} \times 100 \qquad [ Equation 1 ]$$

The target wheel speed calculation unit 240 of the inner wheel may calculate a target wheel speed V_{iw,target} of the inner wheel through Equation 2 by arranging Equation 1 with respect to the target wheel speed V_{iw,target} of the inner wheel.

$${V}_{iw , target} = V - {λ}_{target} \cdot \frac{V}{100} \qquad [ Equation 2 ]$$

Here, V is the current vehicle speed and may be given as distance (kilometer, etc.) per hour.

The ESC unit 100 may include the slip error calculation unit 250. As shown in Equation 3 below, the slip error calculation unit 250 may calculate a slip error, e, between the slip λ of the current inner wheel and the target slip λ_{target} calculated according to Equation 1. Together with the calculated target wheel speed V_{iw,target} of the inner wheel, the slip error e may affect a braking pressure control amount.

e=λ−λ_{target} [Equation 3]

The slip λ of the current inner wheel may be calculated according to Equation 4 below.

$$λ = \frac{V - {V}_{iw}}{V} \times 100 \qquad [ Equation 4 ]$$

Here, V_{iw} may be a wheel speed of the current inner wheel.

The ESC unit 100 may determine the braking pressure control amount based on the target inner wheel speed V_{iw,target} and the target braking torque τ_{target}. That is, the target braking torque τ_{Target} may be determined based on the determined target wheel speed V_{iw,target} of the inner wheel. A target braking amount P_{target} may be determined based on the determined target braking torque τ_{target}. To this end, the ESC unit 100 may include the target braking torque calculation unit 260 and the target braking amount calculation unit 270.

The target braking torque calculation unit 260 may determine the target braking torque τ_{target} according to Equation 5 below. The target braking torque τ_{target} may be a calculation area for determining braking torque for satisfying a target speed and may be calculated based on a correlation between energy and speed.

$${τ}_{target} = \frac{0.5 \cdot W \cdot ( {V}_{iw}^{2} - {V}_{iw , target}^{2} )}{rev} \qquad [ Equation 5 ]$$

Here, W is a vehicle weight specification value, and rev is revolutions-per-minute (RPM) of an engine of a vehicle.

When the target braking torque τ_{target} is calculated, the target braking amount calculation unit 270 may calculate a target braking amount P_{target} according to Equation 6 below. The target braking amount P_{target} may be used to determine a hydraulic braking amount for satisfying the target braking torque τ_{target} and may be determined based on wheel dynamics corresponding to a correlation between wheel torque and braking pressure.

$${P}_{target} = \frac{{τ}_{target} \cdot r}{2 \cdot μ \cdot {r}^{′}} \qquad [ Equation 6 ]$$

Here, r is the radius of a tire, μ is a coefficient of friction of a friction material, and r′ is an effective radius of a brake.

The ESC unit 100 may prevent slip of the inner wheel by applying the determined target braking amount P_{target} to the inner wheel at which slip occurs.

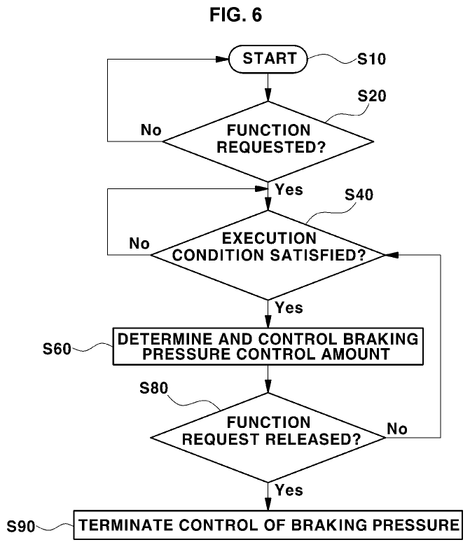

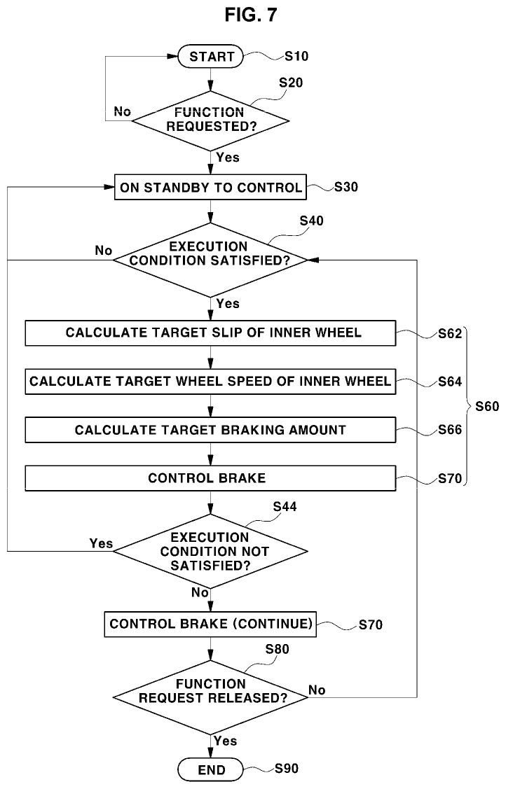

With reference to FIGS. 6 and 7, a brake control method according to the present disclosure will be described below.

In operation S10, the brake control method according to the present disclosure may begin.

In operation S20, a function activation request may be input. The function activation request may be performed by manipulating the activation button of a brake control function according to the present disclosure, which is installed in a vehicle compartment. As a non-limiting example, an ON input of the activation button may be a button for allowing a vehicle to enter a racetrack driving mode. As another non-limiting example, an ON input of the activation button may be a button for allowing a vehicle to enter a drift mode.

When the function activation request is input, the vehicle may enter a standby state for brake control according to the present disclosure (S30). Here, whether the execution conditions for performing brake control according to the present disclosure are met may be determined on standby (S40). Even if the function activation request is input, whether hydraulic pressure control is actually required to prevent wheel slip may be determined. Only when the execution condition is satisfied, brake control according to the present disclosure may be performed.

As described above, the execution conditions may include the turning condition C1, the acceleration condition C2, and the slip condition C3, and when each condition is satisfied, a series of operations for braking pressure control may be performed (S60).

In operation S62, the target slip λ_{target} of the inner wheel may be determined based on a tire characteristic value. The target wheel speed V_{iw,target} of the inner wheel may be calculated according to Equation 2 based on the determined target slip λ_{target} of the inner wheel (S64).

When the target wheel speed V_{iw,target} of the inner wheel is determined, the target braking torque τ_{target} may be calculated according to Equation 5. The target braking amount P_{target} may be calculated according to Equation 6 (S66).

The ESC unit 100 may perform brake control according to the present disclosure by adjusting a hydraulic braking amount of the inner wheel based on the calculated target braking amount P_{target} (S70).

In operation S80, a condition for terminating braking pressure control may be determined. When the function activation request is released, braking pressure control may be terminated (S90). As described above, when there is off input of the activation button by the driver, braking pressure control may be terminated.

When at least one of the turning condition C1, the acceleration condition C2, or the slip condition C3 is not satisfied, braking pressure control may enter a standby state for control (S44). For example, when the steering angle is equal to or less than a preset reference steering angle, the vehicle may enter a standby state for control irrespective of whether other conditions are satisfied, and when all execution conditions are satisfied again, braking pressure control may be performed.

The present disclosure may provide a dynamic driving environment by controlling slip of an inner wheel, which occurs during vehicle turning, using brake control without a mechanical device, such as an LSD, to improve performance for escaping from turning and to facilitate drift (e.g., on a racetrack) and may reduce the cost and weight of a vehicle, development cost, and manpower compared with the prior art.

The present disclosure may provide a method for preventing slip of a turning inner wheel through brake control and for use of the maximum driving force of a vehicle.

The present disclosure may provide a pressure control method and system through conventionally applied electronic stability control (ESC) without a separate system.

The present disclosure may provide a brake control system and method for making a driver have fun of driving a vehicle by improving performance for escaping from turning and facilitating a drift function during driving on a racetrack.

It will be appreciated by persons skilled in the art that the effects that could be achieved with the present disclosure are not limited to what has been particularly described hereinabove and other advantages of the present disclosure will be more clearly understood from the above detailed description.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of controlling a brake, the method comprising:
receiving, by an electronic stability control (ESC) device, a function activation request;
determining, by the ESC device, whether execution conditions for brake control of a turning inner wheel of a vehicle are satisfied in response to the function activation request; and
when the execution conditions are satisfied, controlling braking pressure by determining and adjusting a braking pressure control amount of an inner wheel during vehicle turning based on a preset factor.

2. The method of claim 1, wherein the execution conditions are determined to be satisfied when all of a turning condition configured to determine whether the vehicle is turning, an acceleration condition configured to determine whether the vehicle accelerates, and a slip condition configured to determine a wheel speed difference between the turning inner wheel and an outer wheel are satisfied.

3. The method of claim 2, wherein when a steering angle of the vehicle is greater than a preset reference steering angle, a lateral acceleration of the vehicle is greater than a preset reference lateral acceleration, and a yaw rate of the vehicle is greater than a preset reference yaw rate, it is determined that the turning condition is satisfied.

4. The method of claim 2, wherein when a front wheel speed of the vehicle is greater than a preset reference front wheel speed, driving torque of the vehicle is greater than preset reference driving torque, and when a shift gear of the vehicle is a preset reference stage, the acceleration condition is determined to be satisfied.

5. The method of claim 2, wherein the slip condition is achieved when a slip difference between the turning inner wheel and the outer wheel is greater than a preset reference slip difference.

6. The method of claim 5, wherein an inner wheel during turning is determined based on a yaw rate of the vehicle.

7. The method of claim 1, wherein controlling of the braking pressure comprises calculating a target braking amount based on a target slip and a target wheel speed of the inner wheel during vehicle turning.

8. The method of claim 7, wherein controlling of the braking pressure comprises:
determining the target slip based on characteristics of a tire of the vehicle.

9. The method of claim 8, further comprising:
calculating the target wheel speed of the inner wheel based on the target slip.

10. The method of claim 9, further comprising:
calculating a target braking torque of the vehicle based on the calculated target wheel speed and a current wheel speed.

11. The method of claim 10, further comprising:
determining a target braking amount based on the target braking torque.

12. The method of claim 11, wherein a hydraulic braking amount of the inner wheel is adjusted based on the target braking amount, and the hydraulic braking amount is adjusted by the ESC device of the vehicle.

13. The method of claim 1, wherein when the function activation request is called off, controlling of the braking pressure is terminated.

14. The method of claim 2, wherein:
when at least one of the turning condition, the acceleration condition, or the slip condition is not satisfied in controlling of the braking pressure, controlling of the braking pressure is terminated; and
when all of the turning condition, the acceleration condition, and the slip condition are satisfied again, controlling of the braking pressure is performed.

15. The method of claim 8, further comprising:
calculating a slip error between the target slip and current slip of the inner wheel, wherein the slip error is reflected in the target braking amount.
